(19) United States
(12) Patent Application Publication
(10) Pub. No.: US 2010/0226010 A1
(43) Pub. Date: Sep. 9, 2010

(54) Anti-Shaking Optical Element For Optical Imaging Systems

(76) Inventors: Kai Cheong Kwan, Hong Kong (HK); Tao Pan, Shen Zhen (CN); Sio Kuan Lam, Hong Kong (HK)

Correspondence Address: WELLS ST. JOHN P.S., 601 W. FIRST AVENUE, SUITE 1300, SPOKANE, WA, 99201, US

(21) Appl. No.: 12/398,000

(22) Filed: Mar. 4, 2009

(51) Int. Cl. G02B 27/64

(52) U.S. Cl. 359/555

(57) ABSTRACT

The present invention provides an optical system comprising, at least one lens group for projecting an image on an image sensing means, an optical path being defined between a light entrance of said optical system and said image sensing means, a reflective optical element having convergent or divergent optical power and being located in said optical path, and means for moving the reflective optical element in response to unwanted movement of the imaging system to eliminate or mitigate the negative imaging effect of the said unwanted movement.

### FIELD OF THE INVENTION

This invention relates to an anti-shaking optical element for optical imaging systems, and in particular to such an element that may be used to compensate for image motion resulting from shaking or other undesired motion of the optical imaging system.

### BACKGROUND OF THE INVENTION

The image obtained by a still or video camera can often be blurred and unclear due to undesired motion of the image sensing device. Such undesired motion can result for example from the camera not being held in a stable position, or from the hand-shaking of a user. The problem is particularly severe in the case of low-light (ie long exposure) conditions or where the object being photographed is distant. A number of anti-shaking technologies have been developed to address this problem.

### PRIOR ART

One of the main technologies used for providing an anti-shaking function is the use of optical techniques. Optical anti-shaking technologies minimize the image blur by adjusting the lens position or other optical components or the image sensor to reduce or eliminate the induced image blur caused by hand shaking or other vibrations. Examples of known prior art techniques include U.S. Pat. No. 5,521,758, U.S. Pat. No. 5,771,123, and U.S. Pat. No. 6,606,194.

U.S. Pat. No. 5,521,758 describes a variable-magnification optical system capable of image stabilization in which a rear lens sub-unit is provided that is arranged to tilt with a tilting centre provided at a point on an optical axis. Tilting of this rear lens sub-unit can correct for image shake. U.S. Pat. No. 6,606,194 also describes the use of a lens sub-unit which in this case moves in a direction perpendicular to the optical axis to stabilize an image. U.S. Pat. No. 5,771,123 discloses the use of a variable angle prism unit that is disposed on an image side of the aperture stop.

Anti-shaking systems such as those described above all require an additional optical element to be included in the lens unit which has the disadvantage of increasing the size and weight of the lens unit, and also makes it difficult to retrofit the technology to existing lens units.

Also known in the prior art is WO2007/091112A which uses a gimbaled prism or a mirror located between a window lens and the lens unit. The prism or mirror serves to fold the optical path, and actuators or motors are used to move the prism or mirror in response to motion sensors in order to stabilize the image. Similar to WO2007/091112A are US2007/0035631A and U.S. Pat. No. 7,454,130 both of which use reflective elements to fold the optical path and provide an anti-shaking function.

### SUMMARY OF THE INVENTION

According to the present invention there is provided an optical system comprising, a lens group for projecting an image on an image sensing means, an optical path being defined between a light entrance of said optical system and said image sensing means, a reflective optical element having convergent or divergent optical power and being located in said optical path, and means for moving the reflective optical element in response to unwanted movement of the imaging system to eliminate or mitigate the negative imaging effect of the said unwanted movement.

In embodiments of the invention the reflective optical element may be located between the lens group and the image sensing means, or may be provided within the lens group, or may be provided between the light entrance of said optical system and said lens group. The image forming means may comprise an image sensor or a film.

Preferably the reflective optical element is adapted for tilting movement about an axis that is perpendicular to the optical path, and/or the reflective optical element is adapted for translational movement along said optical path.

### BRIEF DESCRIPTION OF THE DRAWINGS

Some embodiments of the invention will now be described by way of example and with reference to the accompanying drawings, in which:

FIG. 1 is a schematic view of an embodiment of the invention,

FIGS. 2(a) and (b) illustrate tilting motion and translational motion of the reflective optical element in the embodiment of FIG. 1,

FIGS. 3(a) and (b) illustrate alternative forms for the reflective optical element,

FIGS. 4(a)-(d) compare the prior art (FIGS. 4(a) and (b)) with embodiments of the invention (FIGS. 4(c)-(d)) to illustrate advantages of the invention,

FIG. 5 illustrates by way of example one possible method of driving the reflective optical element, and

FIGS. 6(a) and (b) illustrate alternative embodiments of the invention in which the reflective optical element is located in different parts of the optical path.

### DETAILED DESCRIPTION OF PREFERRED EMBODIMENTS

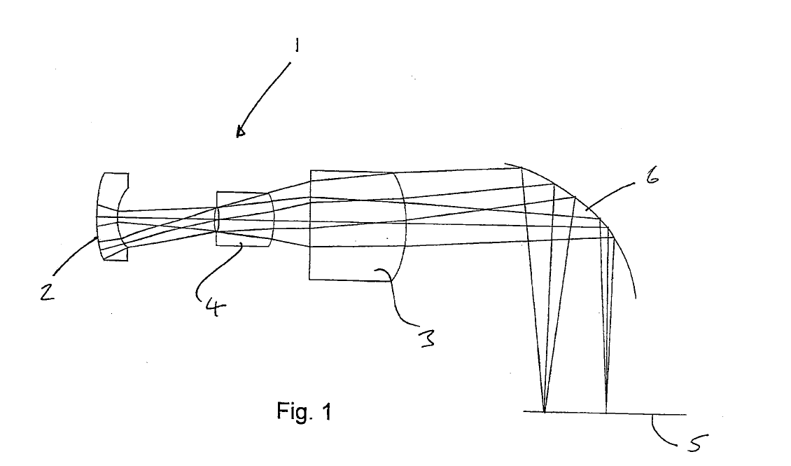

Referring firstly to FIG. 1, there is shown schematically a first embodiment of the invention. An optical system is shown schematically as comprising a lens group 1. Lens group 1 comprises a front lens 2 and a rear lens 3. The lens group 1 may comprise other optical elements such as refractive component 4, or any other known optical elements either alone or in combination. The optical system is designed to produce an image that is formed in an image plane where there is located and image sensing means such as an image sensor 5 or possibly a traditional film. An optical path is defined between the light entrance of the optical system and the image sensor 5.

Located between the rear lens 3 and the image sensor 5 is a reflective functional optical element 6 that folds the optical path. As will be discussed below, the reflective functional optical element 6 is an optical element that has an optical function, that is to say, it is not merely a reflective surface that redirects the optical path but it must also have an optical function such as converging or diverging optical power. The reflective functional optical element 6 is preferably a convergent or divergent mirror, but it may also be a combination of a convergent or divergent reflective surface with a refractive element.

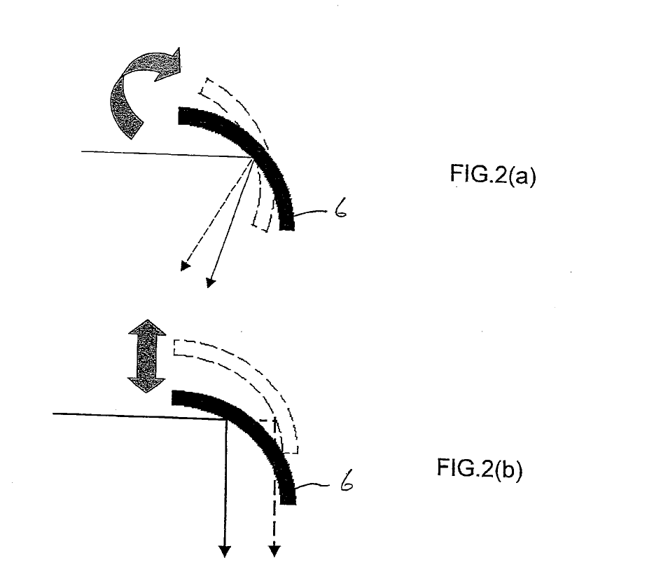

The reflective functional optical element 6 may be moved as shown in FIGS. 2(a) and (b) either with a tilting motion (FIG. 2(a)) or a translational motion (FIG. 2(b)). Considering FIG. 1 and FIG. 2(a) it will be seen that tilting motion is achieved by rotating the reflective functional optical element 6 about the Z-axis that is perpendicular the XY-plane of the figure in which the optical path lies. Translational motion—FIG. 1 and FIG. 2(b) is motion of the reflective functional optical element 6 in the XY plane such that the point of contact of the optical path with the reflective optical element 6 moves along the optical path.

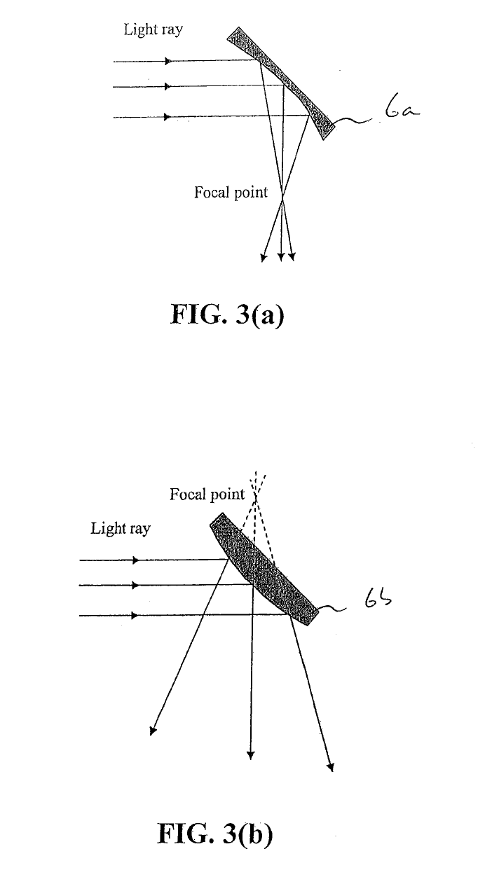

As explained above, the reflective functional optical element 6 is not simply a reflective element or a prism having a reflective surface, but is an element that has an optical function and in particular is an optical element with a converging or diverging optical power. FIG. 3(a) shows a reflective functional optical element 6a provided with a convergent optical power, while FIG. 3(b) shows a reflective functional optical element 6b provided with a divergent optical power. Either a convergent or a divergent reflective optical element can be used in embodiments of the present invention to produce a higher image quality than in the prior art.

By using the convergent/divergent reflective element, the size and the cost of imaging system can be reduced without degrading the image quality. For ordinary folded optical systems (such as a compact camera application), light rays are focused at the imaging surface (sensor surface or film) through at least one lens (refractive optical element) and folded by a simple reflective element. In embodiments of the present invention, a convergent/divergent reflective element shares the imaging focusing function and optical path folding focusing. This can reduce the number of refractive optical elements without degrading the image quality. Thus, the size and cost of imaging system can be reduced as can be seen from the following examples.

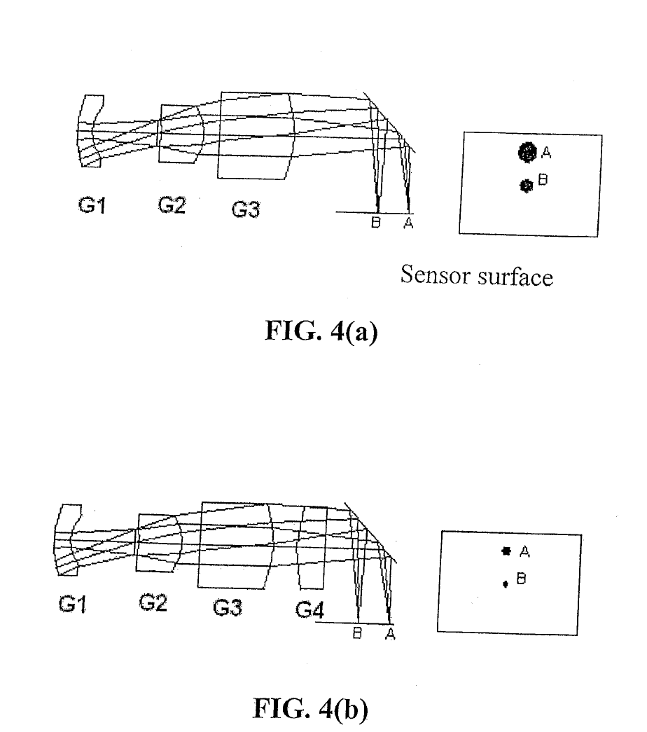

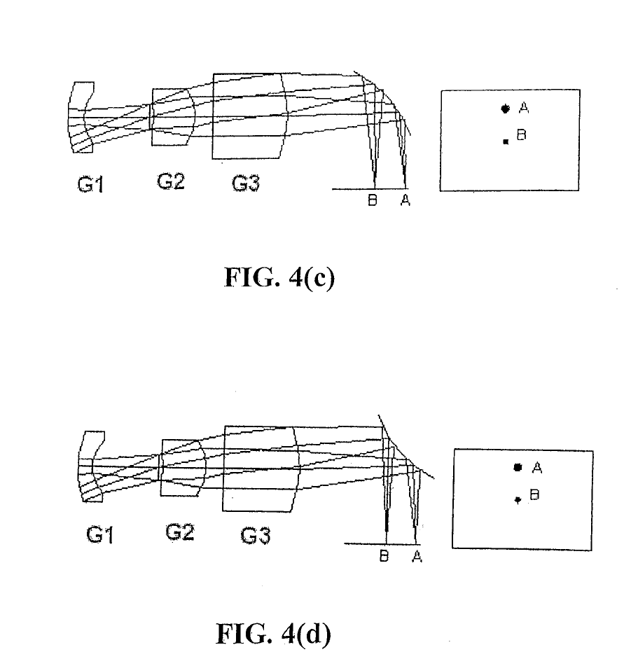

In FIG. 4(a), the system contains three lenses (G1-G3) and one flat plane reflective element as in the prior art. In this system, light rays are focused and images A and B (from point source objects) are formed at the sensor surface. The images of light spots A and B are blurred and occupy extended circular areas. For a good quality image system, the images A and B should be tiny spots (only occupying a single pixel area) rather than a large circular area. Therefore, it can be concluded that the image quality of this system (as shown in FIG. 4(a)) is poor.

In FIG. 4(b), the system contains four lenses (G1 to G4) and one flat plane reflective element. In order to improve the convergent power and image quality, an extra lens (G4) is added into this system. Compared with the arrangement shown in FIG. 4(a), the new formed images A and B are more confined and occupy a smaller area showing that the image quality is improved by adding an extra refractive optical element (G4).

FIGS. 4(c) and (d) show embodiments of the invention in which the system contains three lenses (G1-G3) and one convergent (FIG. 4(c)) or divergent (FIG. 4(d)) reflective element. In this case, the convergent/divergent reflective element assists in focusing the image. In FIGS. 4(c) and (d) the new images A and B are confined and occupy only a small area similar to the image quality of FIG. 4(b) but without requiring the additional lens element G4. It can therefore be seen that the image quality of the system can be improved by using the convergent/divergent reflective element without requiring an extra lens.

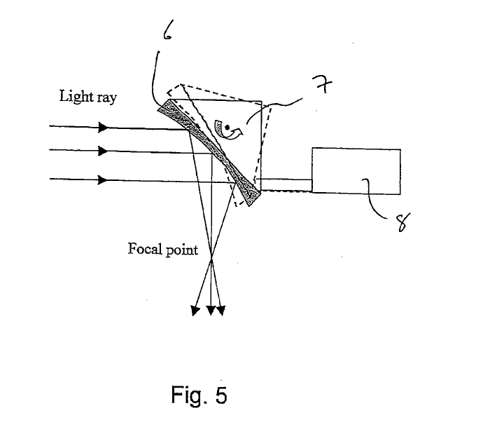

FIG. 5 shows one example of a method for moving the reflective functional optical element 6. The reflective functional optical element 6 is mounted on a rotation block 7 that can rotate about the Z-axis. Rotation of the block 7 about the Z-axis is achieved by using an actuator 8 that responds to controls from a microprocessor control unit (MCU) (not shown) which in turn receives inputs from motion sensors (not shown) such as accelerometers as are known in the field. In response to inputs from the motion sensors, the MCU will generate output signals to the actuator 8 (and other actuators controlling translational motion) with the output signals generated either in response to an algorithm performed by the MCU based on the inputs signals, or generated from look-up tables dependent on the input signals.

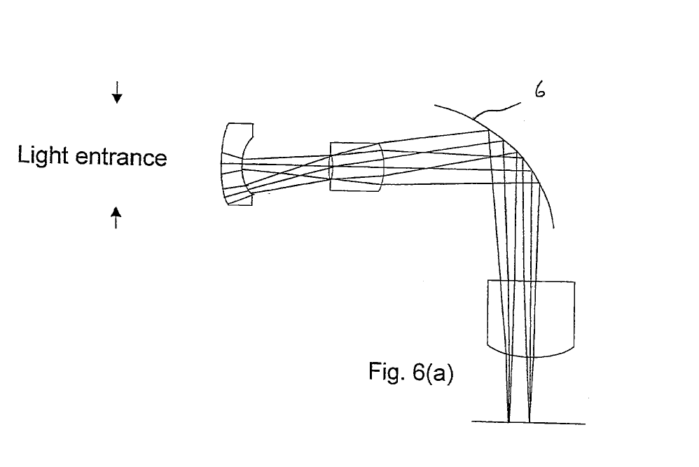

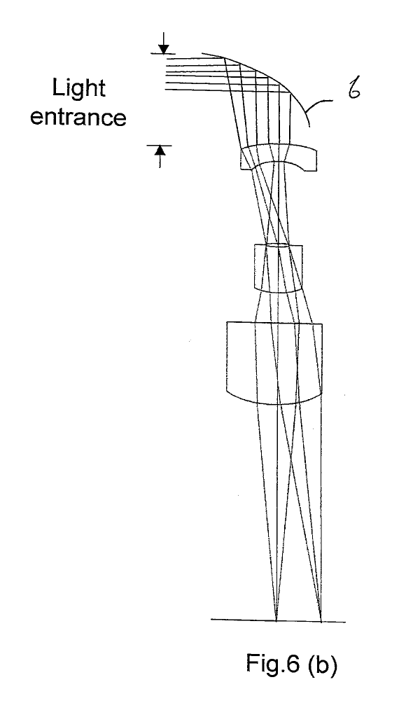

In the embodiment described above the reflective functional optical element 6 is located between the lens group 1 and the imaging sensor 5. Other positions for the optical element 6 are also possible however as shown by FIGS. 6(a) and (b) in which the optical element is located within the lens group 1 in a middle position in the case of FIG. 6(a) and a front position adjacent the front lens 2 in the example of FIG. 6(b). The configuration of FIG. 1 is preferred, however, as it does not interfere with the design of the lens group and may be retrofitted to existing lens groups.

The present invention, at least in its preferred forms, provides an anti-shaking optical element with a number of significant advantages. The anti-shaking function can be provided to an optical system with a minimal increase in size and can serve to reduce the image quality distortion that can otherwise result from unwanted motion of the imaging system. The anti-shaking system of embodiments of the present invention is very flexible and can easily be adapted to existing optical systems, and requires a reduced actuator load compared with the prior art, and also a reduced power load.

1. An optical system comprising, at least one lens group for projecting an image on an image sensing means, an optical path being defined between a light entrance of said optical system and said image sensing means, a reflective optical element having convergent or divergent optical power and being located in said optical path, and means for moving the reflective optical element in response to unwanted movement of the imaging system to eliminate or mitigate the negative imaging effect of the said unwanted movement.

2. An optical system as claimed in claim 1 wherein said reflective optical element is located between said lens group and said image sensing means.

3. An optical system as claimed in claim 2 wherein said reflective optical element is located within said lens group.

4. An optical system as claimed in claim 2 wherein said reflective optical element is located between the light entrance of said optical system and said lens group.

5. An optical system as claimed in claim 1 wherein said reflective optical element is formed integrally with a lens of said lens group.

6. An optical system as claimed in claim 1 wherein said image sensing means comprises an image sensor.

7. An optical system as claimed in claim 1 wherein said reflective optical element is adapted for tilting movement about an axis that is perpendicular to the optical path.

8. An optical system as claimed in claim 1 wherein said reflective optical element is adapted for translational movement along said optical path.
